(19) United States
(12) Patent Application Publication
(10) Pub. No.: US 2012/0026140 A1
(43) Pub. Date: Feb. 2, 2012

(54) DISPLAY DEVICE WITH IMAGE CAPTURING FUNCTION

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/949,807

(22) Filed: Nov. 19, 2010

(30) Foreign Application Priority Data
Jul. 29, 2010 (TW) 99125205

(51) Int. Cl. G09G 5/00; G09G 3/36; H04N 5/225

(52) U.S. Cl. 345/207; 348/207.1; 345/92

(57) ABSTRACT

A display device with an image capturing function includes a power supply and a thin film transistor liquid crystal display (TFT-LCD) and a processing unit. The processing unit includes a capturing module and a control module. The capturing module is placed on a back side of the TFT-LCD, and captures images of an object on a front side of the TFT-LCD. The control module is used for controlling the power supply to switch the TFT-LCD between a light permeating state and a light semi-permeating state. The control module is further used for controlling a capturing rate of the capturing module to be at least an integer multiple of a switch rate of the TFT-LCD between the light permeating state and the light semi-permeating state.

### BACKGROUND

1. Technical Field

The present disclosure relates to display devices and, particularly, to a display device with an image capturing function.

2. Description of Related Art

In general, display devices such as laptop computers usually include a display and a webcam mounted on the top of the display. The webcam usually captures a facial image of a user in response to a user input. However, when another portion of the person's image is needed to be captured, the webcam needs to be rotated or in some cases the display will need to be adjusted until the webcam is aligned with a desired portion of the user. It is time-consuming and inconvenient.

### BRIEF DESCRIPTION OF THE DRAWINGS

FIG. 1 is a block diagram of a hardware infrastructure of a display device with an image capturing function in accordance with an exemplary embodiment.

FIG. 2 shows a user sitting on a front side of the display device of FIG. 1.

### DETAILED DESCRIPTION

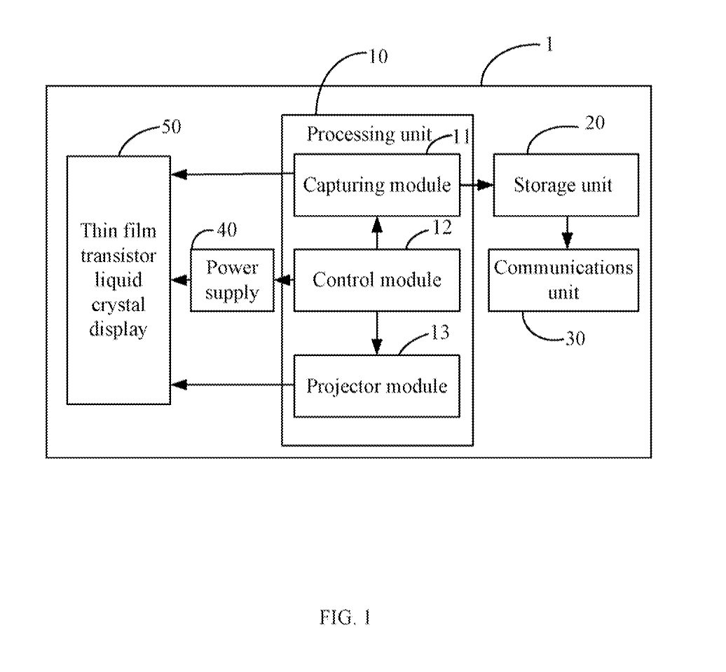

Referring to FIG. 1, a display device 1 with an image capturing function is provided. The display device 1 includes a processing unit 10, a communications unit 30, a thin film transistor liquid crystal display (TFT-LCD) 50, a power supply 40, and a storage unit 20. The TFT-LCD 50 includes two glass substrates (not labeled) and a nematic liquid crystal (not labeled) filled between the two glass substrates. When an electronic field is applied between two electrodes of the two glass substrates, the liquid crystal will react in such a way as to control light to fully pass through the TFT-LCD 50. Otherwise, when there is no electronic field applied between the two electrodes of the two glass substrates, the liquid crystal will not react, causing only a portion of the light to pass through the TFT-LCD 50. In the prior art, when the portion of the light passes through the TFT-LCD 50, the TFT-LCD 50 can function as a rear-projection screen.

The processing unit 10 includes a control module 12, a capturing module 11 and a projector module 13.

The control module 12 is able to control the power supply 40 to switch the TFT-LCD 50 between a light permeating state and a light semi-permeating state.

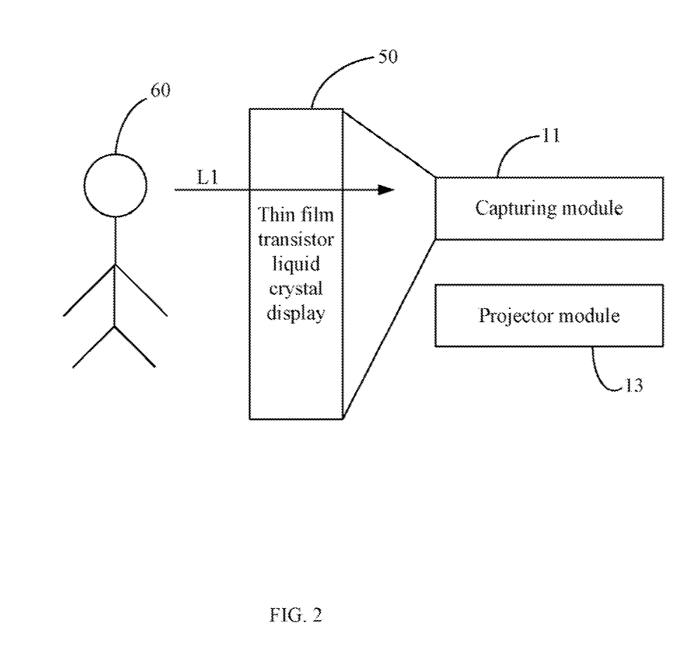

The capturing module 11 is placed on a back side of the TFT-LCD 50. The capturing module 11 is used for receiving the light passing through the TFT-LCD 50 when the TFT-LCD 50 is in the light permeating state, capturing an image of an object on a front side of the TFT-LCD 50 through the received light, and storing the captured image into the storage unit 20. As shown in FIG. 2, a user 60 sits on the front side of the TFT-LCD 50, the light L1 passes through the TFT-LCD 50 when the TFT-LCD 50 in the light permeating state. The capturing module 11 placed on the back side of the TFT-LCD 50 receives the light L1, and captures the image of the user 60 through the light L1.

In the prior art, when the TFT-LCD 50 has a refresh rate of at least 60 HZ, which is adequate for both comfortably viewing and capturing images. In one embodiment, a switching rate between the light permeating state and a light semi-permeating state of the TFT-LCD 50 is more than 60 HZ, due to the fact that a parallax generated by eyes is separated by about 6.5 mm, the user will not feel the switch between two states of the TFT-LCD 50. Furthermore, a capturing rate of the capturing module 11 is at least an integer multiple of the switching rate of the TFT-LCD 50, thereby enabling the capturing module 11 to synchronically capture images with the switch of the two states of the TFT-LCD 50. The communications unit 30 is used for transmitting the captured images stored in the storage unit 20 to other devices in response to a user input.

The projector module 13 is placed on the back side of the TFT-LCD 50, and is used for projecting images on the TFT-LCD 50 when the TFT-LCD 50 is in the light semi-permeating state. In one embodiment, due to the fact that the TFT-LCD 50 is a rear-projection screen in the light semi-permeating state, a user can watch the projected images displayed on the TFT-LCD 50 when the projector module 13 projects images on the TFT-LCD 50.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A display device with an image capturing function, comprising:
a power supply;
a thin film transistor liquid crystal display (TFT-LCD); and
a processing unit comprising:
a capturing module being placed on a back side of the TFT-LCD, and for capturing images of an object on a front side of the TFT-LCD through the TFT-LCD; and
a control module for controlling the power supply to switch the TFT-LCD between a light permeating state and a light semi-permeating state; wherein the control module is further used for controlling a capturing rate of the capturing module to be at least an integer multiple of a switch rate of the TFT-LCD between the light permeating state and the light semi-permeating state.

2. The display device as described in claim 1, further comprising:
a communications unit used for transmitting the captured images to other devices.

3. The display device as described in claim 2, wherein the processing unit further comprises a projector module being placed on the back side of the TFT-LCD, the projector module is used for projecting images on the TFT-LCD when the TFT-LCD is in the light semi-permeating state.

4. The display device as described in claim 1, wherein the capturing module is used for receiving light passing through TFT-LCD when the TFT-LCD is in the light permeating state, and capturing the images of the object in the front of the TFT-LCD through the received light.
